(19) United States
(12) Patent Application Publication
(10) Pub. No.: US 2004/0190691 A1
(43) Pub. Date: Sep. 30, 2004

(54) Means and method for computerized call logging

(76) Inventor: Gustav Schoeman, Johannesburg (ZA)

Correspondence Address: Ward & Olivo, Suite 300, 382 Springfield Avenue, Summitt, NJ, 07901, US

(21) Appl. No.: 10/717,198

(22) Filed: Nov. 19, 2003

Related U.S. Application Data
(63) Continuation-in-part of application No. 10/309,768, filed on Dec. 4, 2002.
(60) Provisional application No. 60/338,775, filed on Dec. 5, 2001.

(51) Int. Cl. H04M 11/00; H04M 1/64

(52) U.S. Cl. 379/88.16; 379/88.22

(57) ABSTRACT

A computerized call logger using a computer having a sound conversion card, which may be a voice modem or a Sound Blaster® compatible card, is used as an input device for receiving voice recordings, such as telephone calls, in digital form. The voice recordings are subsequently compressed and uploaded to a central server where the recordings may be automatically assigned filenames, which are maintained in a database such that a number of computers may be used for logging while a single database may be used to retain information about all logged calls. The server allows authorized remote users to search, retrieve, copy and play recorded calls, from any Internet enabled device, while ensuring that unauthorized users are not granted access to calls. Further, the present invention includes means and apparatus for sending individual calls to recipients via electronic mail and exchanging voice messages over a network, such as the Internet.

CROSS REFERENCE TO RELATED APPLICATIONS

This application is a continuation-in-part of application Ser. No. 10/309,768, filed on Dec. 4, 2002, which claims priority to provisional application No. 60/338,775, filed on Dec. 5, 2001.

### FIELD OF THE INVENTION

The present invention relates to a hardware and software system for logging telephone calls. In particular, the present invention relates to a hardware and software system for logging, storing, and cataloging telephone calls, which are recorded while they are being conducted, and/or voice messages, which may be recorded for delivery via electronic mail (hereinafter referred to as “e-mail”). The recorded messages are stored on a remote server for subsequent retrieval.

### BACKGROUND OF THE INVENTION

Heretofore, businesses have used various types of recording devices and recording systems for logging telephone calls. In particular, businesses have used various types of tape recorders and other devices for logging telephone calls, which may be associated with customer service or other functions conducted by the business. To access telephone conversations stored on the tape-recording devices, a user must fast forward to a location on a tape recording in an effort to locate a specific portion of a conversation, which may be relevant. Transferring the recorded conversation to other parties (either external or internal) requires the call to be recorded again or otherwise transferred to a different user within the business.

Digital recording devices provide random access to specific locations of a particular recording. Accordingly, digital devices and computer software have been designed for recording and storing telephone conversations on computer hard drives. In such systems, the telephone is usually connected directly to a computer or recording device and recording is actuated either by manually activating the recording device or by using computer software.

Several references, which are discussed below, were found to relate to the field of call logging systems. For example, Dawson U.S. Pat. No. 6,252,588 (“Dawson”); Rosen et al. U.S. Pat. No. 5,784,436 (“Rosen”); Bentley et al. U.S. Pat. No. 5,727,047 (“Bentley”); and Hyde-Thomson U.S. Pat. No. 5,717,742 (“Hyde-Thomson”) relate generally to the field of call logging systems.

Dawson discloses a system and method for sending and receiving audiovisual e-mail. In particular, Dawson discloses a software interface that facilitates selecting recipient e-mail addresses, creating audiovisual messages, and recording audio to be included in e-mail. Additionally, Dawson discloses a method for sending the audiovisual e-mail via a telephone connection.

Rosen discloses a system for recording audio received by a telephone on a digital medium within a computer. Specifically, Rosen discloses a system in which a sound card contained within a computer is connected to a telephone line. The Rosen system automatically begins recording whenever a voltage pulse, which indicates an on-hook to off-hook transition, occurs on the telephone line.

Bentley discloses a method for interfacing a personal computer to a telephonic device that is capable of storing data when the computer is off and transmitting the stored data to the personal computer when the computer is on. The telephonic device is connected to an analog telephone line and is capable of storing voice data, caller identification information, facsimile messages, and electronic mail messages.

Hyde-Thomson discloses a method and system for integrating a voice-mail system and an e-mail system. The system assigns a voice mailbox number to each e-mail address. Additionally, the Hyde-Thomson system utilizes a voice gateway computer to receive a voice message via telephone and convert the voice message to a digital audio file. If a caller leaves a voice message for a voice mailbox number that is associated with an e-mail address, the digital audio file associated with the voice message is sent via a network to the e-mail address.

In light of the aforementioned systems, there clearly exists a need for a simple system that allows a user to easily and inexpensively record, store, and retrieve voice messages or telephone calls utilizing standard personal computer equipment. More specifically, there is a need for an inexpensive system that can log voice recordings utilizing standard personal computer equipment and store the voice messages on a central server for subsequent retrieval.

### SUMMARY OF THE INVENTION

The present invention discloses a telephone logging system and method which connects a computer system to a telephone system. The present invention is compatible with cordless telephones, speakerphones, digital private branch exchange (hereinafter referred to as “PBX”) systems, or other like structures.

In a preferred configuration, the present invention enables any personal computer, or equivalent, to act as a “logging system.” The logging system connects to a centralized sever (e.g., through the Internet) which stores all recorded calls. As each call is recorded by the logging system, it is compressed and uploaded for storage on the server. This allows all recorded calls to be stored at one central location. To access the recorded calls or administrative functions possible through the server, a user must first enter a valid user name and password or provide some other means of identification, such as biometric identification data. Once a user has been granted access to the server, the user can access the options available to that user according to that user's profile. For example, some users may only be allowed to listen to previously recorded calls while others may listen to previously recorded calls and record new calls. Alternatively, a user may be assigned to a “group” and thus may access all calls recorded by members of that group. Further, one or more users may be defined as “administrators.” An administrator's access to the system is generally not restricted. Administrators are able to perform various functions such as adding new users to the system, assigning users to a “group,” deleting various recorded calls, or creating a back up of all calls recorded on the server.

The server may include many options for backing up (i.e., secondary storage to avoid lost information) its stored calls. For example, the server may include a CD-Writer for copying the recorded conversations to a CD-R or CD-RW. Alternatively, the server may contain multiple storage devices for operation in a RAID-3 or a RAID-5 configuration. Other systems capable of providing an extra level of redundancy to the system may be utilized.

In addition, there can be one or more centralized servers where each server can be located at a different geographic location. Optionally, the additional servers can be configured as backup servers. The backup servers continuously and automatically mirror and duplicate the primary server for added redundancy and reliability. Alternatively, the servers can be configured in a load-balancing configuration to prevent an overload of the primary server. In this configuration, all servers are configured to accept incoming recordings. The servers can then perform reconciliatory tasks at low load times.

Additionally, the server or servers may be accessed remotely via the Internet. Each server can include software (e.g., a web-server) to allow access to a remote user through a web-based interface to search for or retrieve recorded calls. Therefore, an entitled user can access the server and replay or delete recorded calls from anywhere Internet access is available. A user defined as an administrator may also administrate user accounts through the web-based interface as well.

In addition, the present invention includes software, which automatically assigns names to the digital sound files so that calls are automatically logged in a standardized manner. Another part of the system includes a database, which is used to store information about a call, including the name assigned to the computer file, its participants, and its subject. The database is generally a single database implemented on the server, and thus may be used over a local area network (“LAN”), wide area network (“WAN”), or Internet connection, to allow call information relating to calls involving multiple users to be accessed from a single database.

Another feature of the present invention is the ability to allow users to identify specific calls, as well as to mark particular portions of calls for later access.

In addition, the present invention may send recordings or voice messages by electronic mail (“e-mail”) to others. The invention allows for various methods of sending e-mail. In a first embodiment, a user can download a recording from the central server, and attach the recording to an e-mail as a file. Alternatively, the central server can present a user with a web-interface to e-mail a recording directly from the server without the intermediate download.

The system of the present invention has multiple applications to many industries. For example, the present invention is well suited for use in the healthcare industry. The present invention may be utilized to record and access vital conversations with insurance companies or Medicare. The present invention may also be used to preserve verbal orders to hospitals, pharmacies, other health care providers, or patient families.

The present invention also has multiple possible applications in financial and business institutions. For example, the present invention may be used to eliminate “he said, she said” situations in which two parties are in dispute. The present invention can also confirm and permanently store all client instructions, bank transaction authorizations, and buy/sell orders. Recorded conversations may also be utilized in training new personnel.

Another application of the system is to reduce unwanted personal calls by staff. It is evident that staff members tend to make less personal calls if it is known that such calls are being recorded.

The system can also be used for taking notes, or as a dictation or transcribing system. With the appropriate microphone, the system can also be used to record and save meetings. Finally, the system can also be used to record focus groups at market research companies.

As is evident to one skilled in the art, many other applications of the present invention are also possible to other institutions including, but not limited to service facilities, help lines, call centers, insurance agencies, and professional service firms.

Therefore, it is an object of the present invention to provide a telephone logging system that is capable of logging telephone conversations from a plurality of telephone lines and storing them on a central server.

It is an additional object of the present invention to provide a telephone logging system that is secure.

It is a further object of the present invention to provide a telephone logging system that can be administrated from a central server.

Furthermore, it is an object of the present invention to provide a telephone logging system capable of compressing the recorded telephone conversations.

It is an additional object of the present invention to provide a telephone logging system that is cost effective and easy to use.

It is another object of the present invention to provide a highly reliable telephone logging system that has built-in redundancy.

It is a further object of the present invention to provide a telephone logging system that is accessible from a remote location via the Internet or other communication medium.

Furthermore, it is an object of the present invention to provide a telephone logging system in which the recorded telephone calls can easily be searched and replayed.

Other objects, features, and characteristics of the present invention, as well as the methods of operation and functions of the related elements of the structure, and the combination of parts and economies of manufacture, will become more apparent upon consideration of the following detailed description with reference to the accompanying drawings, all of which form a part of this specification.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

FIG. 1 is a schematic representation of the hardware of the preferred embodiment of the present invention including a computer, monitor, keyboard, mouse, telephone, and a hardware interface unit, which interfaces the computer to the telephone.

FIG. 2 is a plan view of the back of the computer shown in FIG. 1 in accordance with the preferred embodiment of the present invention in which a sound card interfaces audio signals to the computer.

FIG. 3 is a plan view of the back of the computer shown in FIG. 1 in accordance with an alternate embodiment of the present invention in which a voice modem or other telephony device interfaces audio signals to the computer.

FIG. 4 is a schematic representation of the hardware interface according to the preferred embodiment of the present invention illustrating the manner in which the hardware interface is connected between a telephone handset, a telephone base, and a computer.

FIG. 5 is a schematic representation of the hardware interface according to an alternative embodiment of the present invention illustrating the manner in which the hardware interface is connected between a telephone line, a telephone base, and a computer.

FIG. 6 is a schematic representation of a plurality of computers, each equipped with the hardware and software of the present invention, illustrating the manner in which a plurality of computers may be networked together to share a single database.

FIG. 6A is a screen shot of the log-in screen utilized to restrict access to the recorded calls stored by the system of the present invention.

FIG. 6B is a screen shot of the query screen utilized to access and sort the recorded calls stored by the system of the present invention.

FIG. 7 is a flowchart illustrating the operation of the software of the present invention.

FIG. 7A is a screen shot of a pop-up window which appears when a call is recorded.

FIG. 7B is a screen shot of a pop-up window which allows a user to enter information about a call.

FIG. 8 is a flow chart illustrating the recording and compression of a call by the software of the present invention.

FIG. 9 is a circuit diagram of the preferred embodiment of the telephone base-to-handset hardware interface of FIG. 4.

FIG. 10 is a circuit diagram of an embodiment of the telephone line-to-telephone base hardware interface of FIG. 5.

FIG. 11 is a circuit diagram of an alternate embodiment of the telephone base-to-handset hardware interface of FIG. 4.

### DETAILED DESCRIPTION OF THE PREFERRED EMBODIMENT

As required, a detailed illustrative embodiment of the present invention is disclosed herein. However, techniques, systems, and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention. The following presents a detailed description of a preferred embodiment (as well as some alternative embodiments) of the present invention.

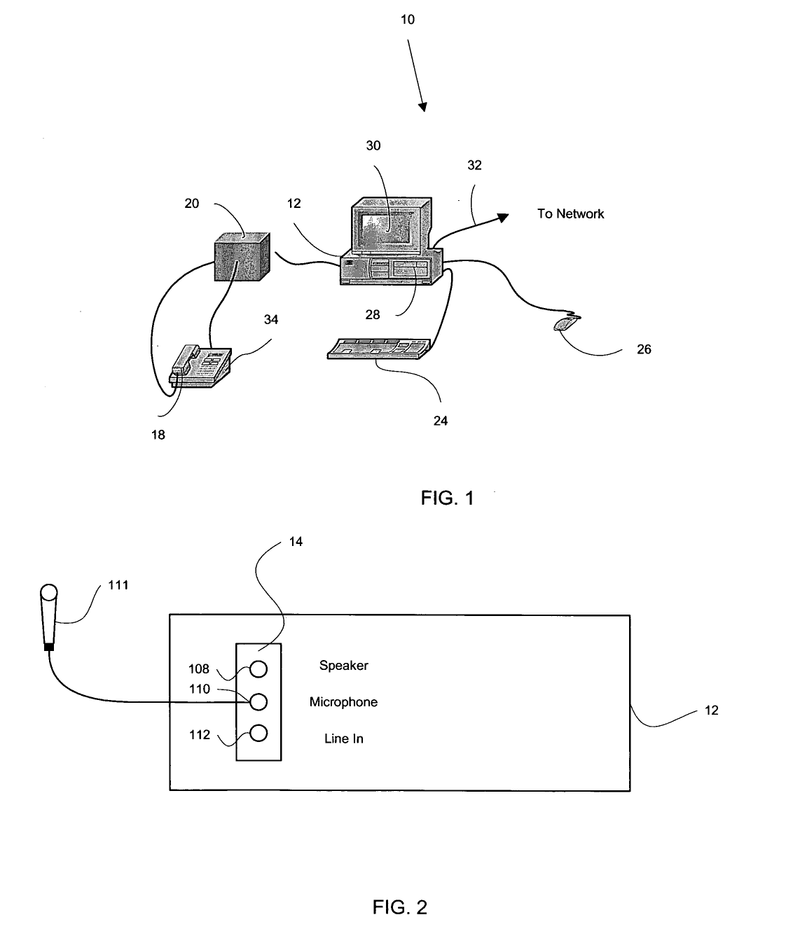

Referring first to FIG. 1, in accordance with the present invention, a telephone call logging system 10, which may be used to both record calls (or other voice messages) and to enter them into a database, is disclosed. In addition, the design of the call logging system 10 of the present invention allows several such systems to be interfaced to separate telephones in such a way that calls logged at any one of the telephones may be retained in a central database on a central server. In one embodiment, the present invention may be used with speakerphones or cordless telephones, whereas in another embodiment, the present invention may be used with all computer telephony systems including digital PBX, ISDN lines, or broadband lines.

As will be understood by those skilled in the telephone art, when one connects a device, such as the call logging system 10 of the present invention, to the telephone line, it is necessary for the device to comply with the requirements of Federal Communications Commission (hereinafter referred to as “FCC”) Part 68. Thus, if a device is connected between a telephone and a telephone jack in the wall, that device must be FCC Part 68 compliant. On the other hand, if a device is connected between the telephone handset and the telephone base, FCC Part 68 compliance is not necessary. In accordance with the present invention, different interfaces may be used and by selecting an appropriate interface, different benefits may be achieved.

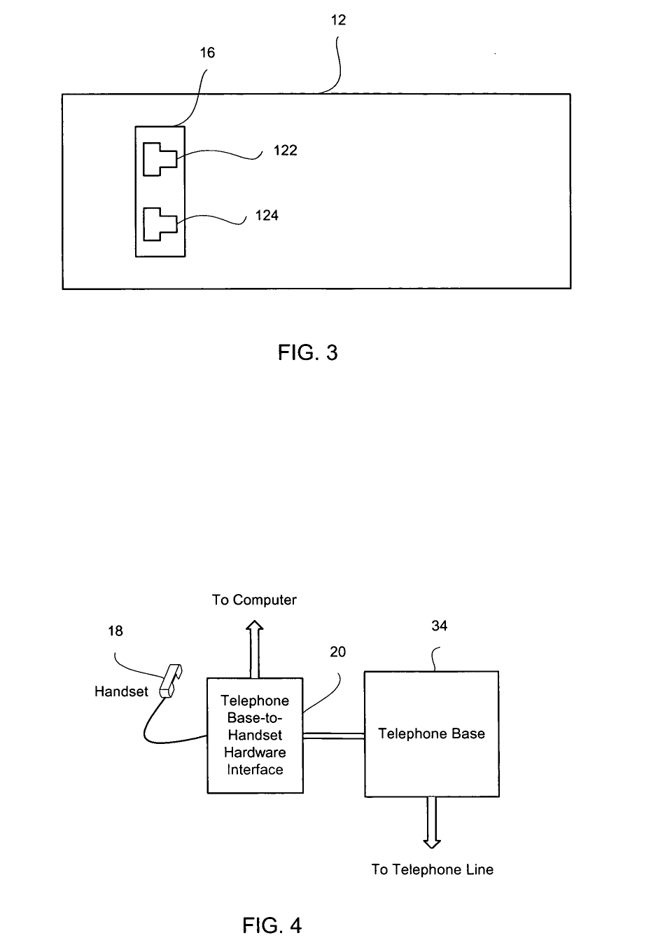

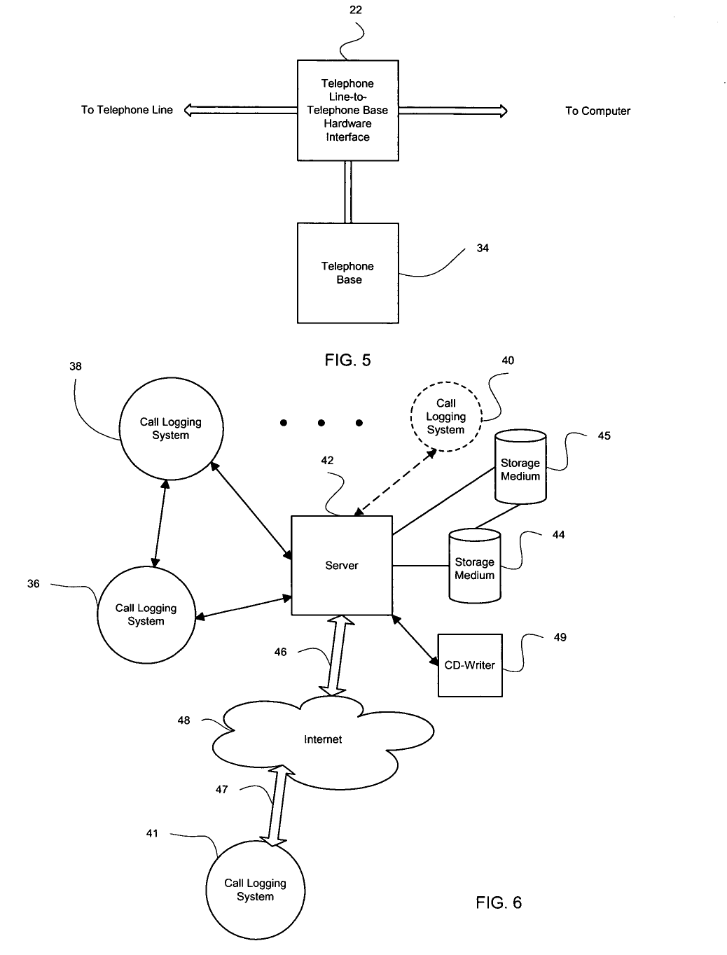

As shown in FIG. 1, the call logging system 10 of the present invention is comprised of a computer 12, such as an IBM-compatible personal computer. The computer 12 includes an audio device therein, which is capable of receiving analog audio signals and converting them to digital format for storage. As will be understood by those skilled in the art, the audio device within the computer will typically comprise an accessory card, such as a Sound Blaster® compatible sound card 14 (See FIG. 2). Alternatively, a voice modem or other telephony device 16 (See FIG. 3) or any other combination of hardware and software, which can receive an analog audio signal and convert it to a digital form, may be used. Those skilled in the art will recognize that the relevant issue in the selection of the audio device is the capability for receiving audio signals and interfacing them to the computer 12.

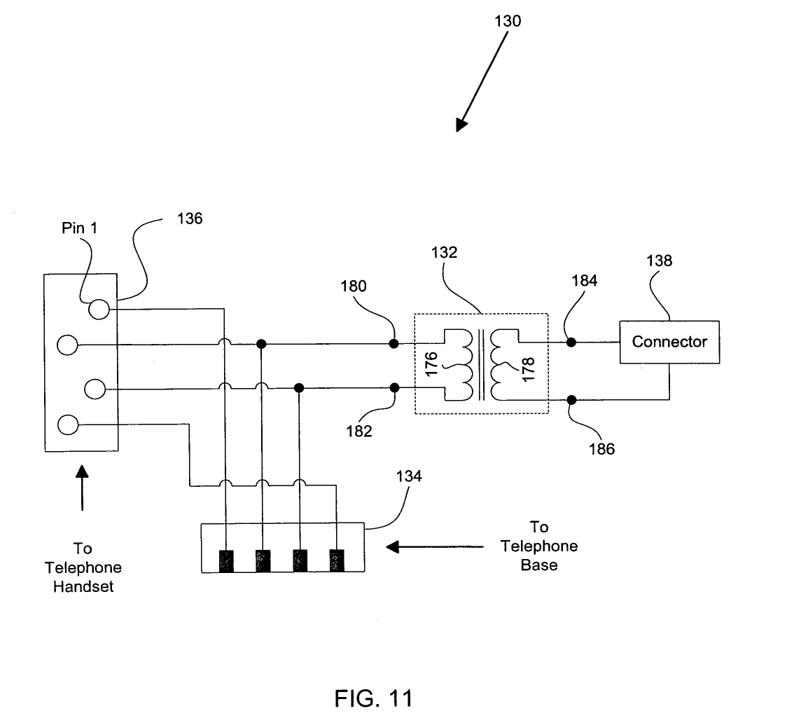

The present invention will be described in accordance with the preferred embodiment in which a Sound Blaster® compatible sound card 14, as shown in FIG. 2, is used. Those skilled in the art will recognize that a voice modem or other telephony device 16 or similar structures, as shown in FIG. 3, could be used as well. Telephony device 16 comprises first jack 122 and second jack 124. Telephone device 16 is described in greater detail supra with respect to FIG. 11.

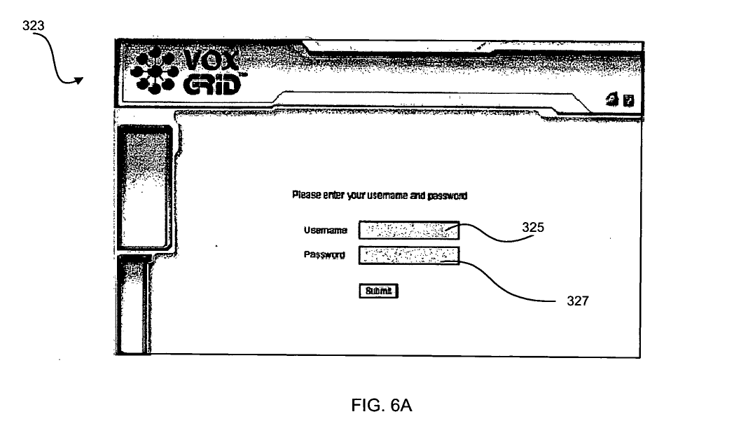

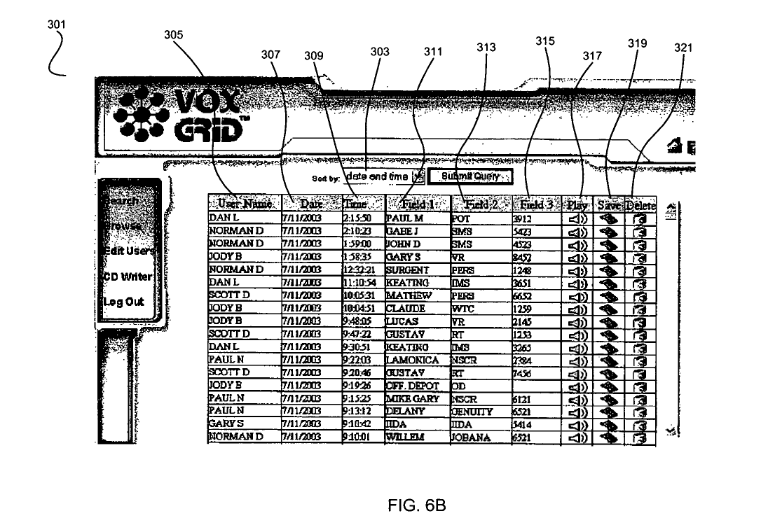

With continued reference to FIGS. 1 and 2, a telephone base 34 having a handset 18 is connected to telephone base-to-handset hardware interface 20. In the preferred embodiment of the present invention, the telephone base-to-handset hardware interface 20 is connected between the telephone base 34 and its handset 18 as shown in FIG. 4. Alternatively, a telephone line-to-telephone base hardware interface 22 may be selected which is connected between the telephone line and the telephone base 34 as shown in FIG. 5. Those skilled in the art will recognize that if a voice modem or other telephony device 16 is used, the voice modem or telephony device 16 may take the place of the telephone line-to-telephone base hardware interface 22.

Although the telephone line-to-telephone base hardware interface 22 of FIG. 5 must be FCC Part 68 compliant, this type of interface may be used with speakerphones or cordless telephones. In addition, if a telephone line supports multiple telephones, such as a typical residential telephone line, all telephones may be connected using a telephone line-to-telephone base hardware interface 22. On the other hand, a typical analog telephone line-to-telephone base hardware interface 22 cannot be used to interface a digital telephone line (such as an ISDN line or a broadband line) to a computer.

An advantage of the telephone base-to-handset hardware interface 20, as illustrated in FIGS. 1 and 4, is that it does not have to be FCC Part 68 compliant since it does not connect directly to the telephone line. In addition, the telephone base-to-handset hardware interface 20 may be used with a digital PBX, an ISDN line, or a broadband line. Since businesses which regularly log telephone calls, such as customer service operations, will typically have digital telephone lines and computers for each user, the telephone base-to-handset hardware interface 20 is considered to be the preferred embodiment of the hardware interface.

Still referring to FIG. 1, the computer 12 typically also includes a keyboard 24, a pointing device 26 (e.g., a mouse), storage media 28 (e.g., floppy disk drive, hard drive, re-writeable Compact Disc (CD-RW) drive, Digital VideoDisc (DVD) drive, Iomega® Zip® disk drive, removable hard drive, memory card, etc.), a monitor 30, and preferably a network interface card (or built in network interface) which allows the computer 12 to be connected by wire 32, radio frequency (RF)(not shown), or other means (not shown) to a local area network (LAN), wide area network (WAN), or the Internet.

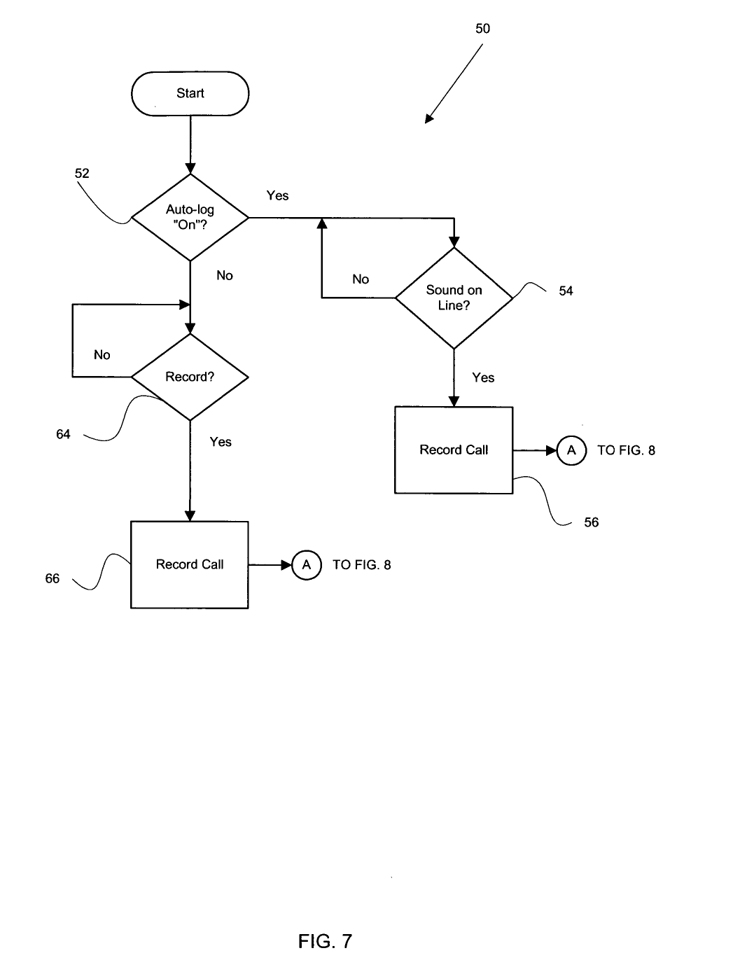

Turning next to FIG. 6, call logging systems 36, 38, and 40 may be connected to each other and to a server 42 via a LAN or WAN. Server 42 may also be given a public IP address, in which case call logging systems may connect to server 42 over any Internet connection. In FIG. 6, call logging system 41 utilizes Internet connection 47 to access server 42. Internet connection 47 may be any standard Internet connection including, but not limited to, dial-up, cable, DSL, T1, wireless, etc. Server 42 similarly connects through the Internet via connection 46, which also may be any standard Internet connection.

Generally, call logging systems that access server 42 utilize standard hypertext transfer protocol (http) for communication. This communication may also be encrypted using standard techniques such as utilizing https (the http protocol layered over the secure socket layer (SSL) protocol to allow secure data transfer using encrypted data streams) or algorithms that utilize public and private keys. Such security measures ensure that the transmission of data between a call logging system and the server is secure.

Server 42 preferably utilizes the Linux operating system. However, other operating systems are also compatible with the system of the present invention including, but not limited to Microsoft Windows Server, UNIX and Macintosh OS. In accordance with the present invention, the server 42 may include a storage medium 44, such as a hard drive, to retain a database including information about the calls logged on the various call logging systems 36, 38, and 40. Server 42 preferably utilizes the database MySQL although any alternative such as PostgreSQL, Oracle, Microsoft Access or Microsoft SQL server can be utilized. Server 42 also contains a CD-writer 49 which allows recorded calls to be archived on a CD-RW or CD-R disc. In the preferred embodiment, calls are stored at 1.6 kilobits per second.

Server 42 allows for the administration of several call logging systems (e.g., 36, 38, 40) from one central location. In the preferred embodiment of the present invention, server 42 restricts access to users. If server 42 is given a public IP address, it is important to ensure the security of server 42 to prevent unauthorized access to a company's recorded telephone calls. To restrict access, server 42 may require a username and password to be accessed. As another example, a user may be required to provide biometric information, such as a fingerprint or retina image, to access server 42. Any combination of such security devices and measures is compatible with the present invention. Each call logging system (36, 38, and 40) may also contain similar security measures to prevent unauthorized access to the system. For example, FIG. 6A depicts a screen shot of how server 42 may restrict access to users. Specifically, if a user attempts to access server 42 (e.g., through an Internet connection), the user first receives login window 323. Login window includes username field 325 and password field 327. A valid user name and password must be supplied before a user is granted access to server 42. Alternative security methods such as fingerprint or retinal scan operate in a similar fashion.

Now referring back to FIG. 6, once an administrator has been granted access to server 42, the administrator may utilize software located on server 42 to edit user account information stored in a user account database on storage medium 44. Different accessibility options may be set for each user of the system. For example, certain users may only be allowed to record calls while other users may only be allowed to listen to previously recorded calls. To facilitate user account administration, users may be automatically assigned accessibility rights using pre-established accessibility profiles. For example, all administrators of the system may be assigned the accessibility profile of “administrator” which would grant the administrator full access to all options available through the user of server 42. Such a user would be allowed to record calls, replay previously recorded calls, administrate user accounts, delete previously recorded calls, etc. In a similar manner, users with less authority may be assigned the accessibility profile of “personnel.” A user with this designation, for example, would only be allowed to record calls and listen to previously recorded calls. Finally, a group may be created comprising users with common characteristics (e.g., in the context of a call center, a group may be all representatives with a common skill set). Members of a group may be given common privileges, such as the ability to listen to all calls recorded by members of that group.

Server 42 additionally contains a second storage medium 45 for archival purposes. For example, server 42 may periodically create a backup on storage medium 44 on storage medium 45 for redundancy. However, storage medium 44 and storage medium 45 may also function jointly in a RAID 3 configuration if storage mediums 44 and 45 are both hard drives. Server 42 is shown only having storage medium 44 and storage medium 45. However, it should be apparent to one skilled in the art that any number of storage mediums may be combined in any fashion (e.g., RAID 5, etc.) to provide redundancy and reliability.

Periodically, server 42 also initiates a backup of storage medium 44 utilizing CD-writer 49. The server may initiate the backup automatically (e.g., once a week, or after a predefined number of calls have been recorded). Alternatively, an administrator can manually initiate a backup of storage medium 44. CD-writer 49 is capable of creating a “hard copy” of the recorded calls on storage medium 44 by copying the files to either a CD-R or a CD-RW. These “hard copies” have the advantage that they can be taken to a geographically distinct location and put away for safekeeping. Therefore, if storage medium 44 is ever destroyed or corrupted, the “hard copies” can be retrieved and the call database can be restored.

The present invention also allows the option to have multiple servers, where each server is at a geographically distinct location. In one embodiment the additional servers continuously and automatically mirror and duplicate the primary server for added redundancy and reliability. Alternatively, the servers can be configured to perform load balancing. Each server can accept incoming recordings to prevent one server from overload. In this embodiment, the servers can perform reconciliatory tasks during low load periods.

Users are also able to access server 42 to search through previously recorded calls. For example, shown in FIG. 6B is a screen shot of query window 301 utilized to search, view, and replay the recorded calls. Query window 301 consists of sort function 303, user name column 305, date column 307, time column 309, first name column 311, last name column 313, data column 315, play column 317, save column 319, and delete column 321. Sort function 303 allows a user to sort the recorded calls utilizing a number of predetermined sort methods. For example, a user may use sort function 303 to sort the recorded calls by date and time, first and last name, username, etc. User name column 305 lists the username of the user who recorded the call. Similarly, date column 307, time column 309, first name column 311, and last name column 313 list the date, time, first name of the called/calling party, and the last name of the called/calling party, respectively. Data column 315 is utilized to store any additional information about the recorded call. For example, data column 315 may list the last four digits of the called telephone number as shown. Alternatively, data column 315 may store computer-telephony integration (“CTI”) information such as caller identification information, dialed number information, etc. Play column 317, save column 319, and delete column 321 are utilized to replay the recorded call, save the recorded call, or delete the recorded call.

Query window 301 is accessible from call logging system 10 (FIG. 1) or server 42 (FIG. 6) via software. However, query window 301 may also be accessed remotely via the Internet. In this manner, a remote user can replay and search through the recorded conversations without being physically present. In the preferred embodiment, a remote user can view query window 301 utilizing a standard web-browser.

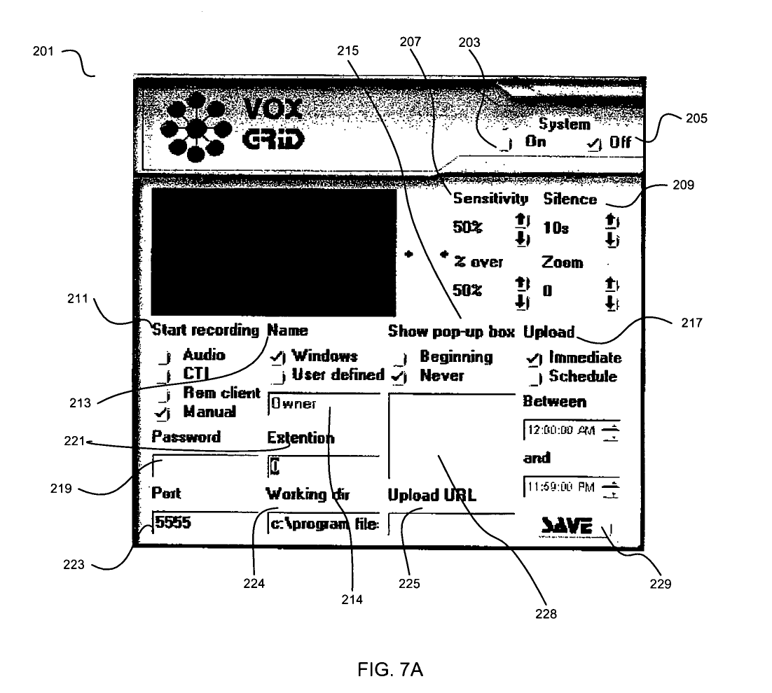

Now with reference now to FIG. 7, a flowchart is shown illustrating the software operation of the present invention. This software is installed on all call logging systems and is necessary for recording calls, however, the software is not needed to view query window 301 (FIG. 6B). The present invention includes software, which operates on the computer 12 (See FIG. 1) to perform a variety of functions, as will be understood with reference to flowchart 50. In particular, the software operation includes an Auto-Log function, which enables the software to automatically log telephone calls. The Auto-Log function may be set either on or off in step 52. If the Auto-Log function is set to be “on,” the Auto-Log function operates by “listening” to the telephone line and measuring the input level at the sound card to determine whether it exceeds a preset threshold value (step 54). More specifically, the software first analyzes the data sampled from the call and calculates how many sound samples' volumes exceed the preset threshold value. Then, the percentage of the samples that exceeds that threshold is calculated. Four of these values are added and the average is calculated. If this average is above a user-defined threshold, the recording is started. Alternatively, if the Auto-Log function is off, a recording is started at the user's request (e.g., when the user clicks on a “Record” button on the screen of the monitor 30 using the pointing device 26 or when the user enters a command using the keyboard 24) (step 64). Recording may alternatively be activated via a button (not shown) located on telephone base-to-handset hardware interface 20 (FIG. 4) or telephone line-to-telephone base hardware interface 22 (FIG. 5). It should be noted that even if the Auto-Log function is on, a recording could be started manually. Alternatively, the system may use computer telephony integration “CTI” capabilities to automatically recognize the start of a call.

Once recording has begun, the user is provided with pop-up window 201 as shown in FIG. 7A. Pop-up window 201 may be configured to automatically be displayed upon the start of a call. Pop-up window 201 may be utilized to control the settings utilized by call logging system 10. Pop-up window 201 consists of system on button 203, system off button 205, sensitivity setting 207, period of silence setting 209, recording setting 211, user name setting 213, user name field 214, pop-up window setting 215, upload setting 217, password field 219, extension field 221, port field 223, working directory field 224, upload field 225, tag field 228, and save button 229 as well as other like call attribute functions. System on button 203 and system off button 205 are utilized to control the on/off recording status of call logging system 10. For example, if system off button 205 is selected (as shown in FIG. 7A), call logging system 10 will not record any telephone conversations even if the option to automatically record telephone conversations is selected.

Sensitivity setting 207 is utilized to control the sensitivity of the Auto-Log function. If sensitivity setting 207 is set to a high percentage, the Auto-Log function will start recording a call only if the sounds on the telephone line are very loud. Similarly, if sensitivity setting 207 is set to a low percentage, the Auto-Log function will begin recording a call after almost any sound has occurred. Silence setting 209 is utilized to control the amount of silence allowed after the Auto-Log function has begun recording. As shown, call logging system 10 would stop recording a telephone conversation after a period of silence of ten seconds is detected during the call.

Recording setting 211 allows a user to select the method of recording utilized by call logging system 10. For example, if “audio” is selected from recording setting 211, call logging system 10 will utilize the Auto-Log function to record calls. If “manual” is selected, as shown, call logging system 10 will begin recording a call only after a user has manually activated call logging system 10 by utilizing software or by pressing a “record” button located on telephone base-to-handset hardware interface 20 or telephone line-to-telephone base hardware interface 22.

User name setting 213 allows a user to control the user name associated with a recorded call. In this example, two options are provided as to how this user name is determined: “Windows” and “user defined.” If the “Windows” option is selected, the user name assigned to a call will be the user's log-in ID (i.e., the ID the user provided to log-in to the computer). The system automatically assigns this log-in ID without further prompting the user. If the “user defined” option is selected, the user name assigned to a call must be entered in user name field 214.

Pop-up setting 215 allows a user to control the behavior of pop-up screen 201. For example, if “beginning” is selected, pop-up screen 201 will appear each time a call has been recorded. In a similar manner, if “never” is selected from pop-up screen setting 215, pop-up screen 201 will only appear if activated by a user.

Upload setting 217 is utilized to control when recorded calls are transferred to server 42. If the “immediate” option is selected, the .wma file is transferred to server 42 immediately after its creation. However, if “schedule” is selected, the recorded calls are only uploaded during the time period specified by the “between” field and “and” field.

Password field 219 functions to prevent unauthorized users from changing settings. Thus, password field 219 prevents users from disabling the program. This feature is especially useful for call center environments where it is required that all calls be recorded.

Extension field 221 allows the user to associate a user's telephone extension with his name and recordings. This field is especially useful in a CTI environment where the CTI system indicates to the recorder to start and stop recording. The CTI system refers to the client by its telephone extension.

Port field 223 is the port that the CTI server communicates on. This port can be set programmatically to any number from 1020 through 65536. Although privileged ports 1 through 1019 may be used, 1020 through 65536 are the preferred ports.

URL field 225 is utilized to communicate with server 42. Specifically, server 42 is given a public IP address, and utilizes software that monitors a specific communications port (preferably port 80 to prevent problems with firewalls) to detect communications with call loggers. Therefore, in order to upload calls to a server, upload URL field 225 must indicate the proper URL for server 42. Alternatively, the default port for the server can be set to 443 if the HTTPS/SSL (secure communications) is utilized.

Tag field 228 is utilized to allow a user to specify what information will be provided with a call. For example, if a user wishes to specify the caller's name, company and account number for a specific call, the user can type tags such as “Name,” “Company” and “Acct #” in tag field 228.

Finally, save button 229 is utilized to save the settings assigned to call logging system 10 as shown in pop-up window 201 as well as the recorded call which caused pop-up window 201 to appear.

A user may also be provided with call information window 230 at the beginning of recording or during the course of recording as shown in FIG. 7B. The tags entered by the user in tag field 228 are displayed in the call information window with corresponding information fields. In the example depicted in FIG. 7B, the user filled in tags of “Name,” “Company” and “Acct #,” as can be determined by tag titles 231, 233 and 235. Below each title are corresponding fields 237, 239 and 241. The user provides information in each of these corresponding fields and this information is sent to the server for storage with the call. The information is also included in the database record for that call.

Alternatively, utilizing computer telephony integration (“CTI”) functions of the system, information about a call can be determined automatically. For example, utilizing Automatic Number Identification (“ANI”), the calling number and caller's name can automatically be determined. Utilizing this feature, certain information about a call can automatically be determined and uploaded to server 42.

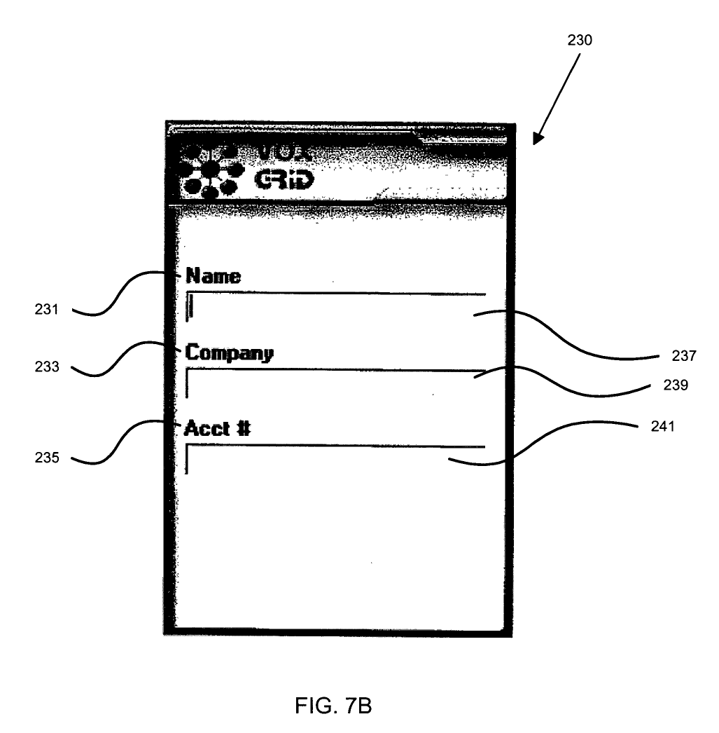

Now referring to FIG. 8, when recording begins, a filename is created and a file is opened (step 74) and optionally a new database entry is created for the call on the call logging system's local database (step 76). Alternatively, the call logging system need not include a local database, in which case only the file is created and opened.

Preferably, the filename is constructed by the software in the form “yyyymmddhhnnsszzz,,” with a “.wma” extension where “yyyy” corresponds to a four-digit year, “mm” corresponds to a two-digit month, “dd” corresponds to a two-digit day of the month, and “hhnnsszzz” corresponds to a 24-hour time in hours, minutes, seconds, and milliseconds with the date and time corresponding to the date and time when the filename is created. The “,,” behind the date can be reserved for other naming information as necessary. Of course, other forms of filenames may be used. The “.wma” extension corresponds to the standard extension used for compressed wave (audio) files, which are playable with any Microsoft® Windows® compatible media player, such as Microsoft® Windows® Media Player. However, it should be apparent to one skilled in the art that any other audio format (.mp2, .wav, .mp3, etc.) or media player (Winamp, Music Match, etc.) may be utilized with the present invention. Thus, in accordance with the preferred embodiment of the present invention, a recording that commences on Nov. 13, 2001 at 25.123 seconds after 3:37 in the afternoon will be assigned the filename “20011113153725123,,.wma”. Alternatively, the file name may be initially saved with a “.wav” extension (i.e., uncompressed audio) and then be subsequently compressed and converted to a “.wma” file.

As will be known to those skilled in the art, sound cards, such as Sound Blaster® compatible cards, include a buffer (i.e., a reserved segment of memory utilized to hold data while it is being processed), which stores the sampled input in digital form. The system then begins and monitoring the buffer to determine when it is full (step 80). When the buffer is full, the sound card raises an “event,” which initiates a routine in the software to cause the software to update the .wav file by updating its header and extending the file length (step 82). Extending the file length includes transferring the digital data from the buffer to the “.wav” file.

The end of a recording (step 78) is indicated by either a predetermined period of time, e.g., ten seconds, during which the intensity at the input of the sound card is less than the preset threshold (when Auto-Log is on) or when the user requests that the recording stop (e.g., by clicking on a “Stop” button with the pointing device 26 (when Auto-Log is off). In other words, if Auto-Log is on, the call is automatically recorded when the intensity of the signal on the telephone line exceeds the preset threshold and the recording ends when the predetermined silence period has been reached. It is also foreseeable that other like detecting functionality may be used such as a click and pop-detection, etc. Alternatively, the call will be recorded until a “Stop Recording” command is entered by the user (step 78). Recording may also be stopped by pushing a button located on telephone base-to-handset hardware interface 20 or telephone line-to-telephone base hardware interface 22. It would be obvious to one skilled in the art that a variety of detection methods may be implemented including, but not limited to: voltage level detection, current flow detection, peak detection etc. Other mechanical methods may also be used, (e.g., having a mechanical switch when the user picks up the handset).

Upon detection of the signal to end the recording (step 78), the software flushes the buffer of the sound card (i.e., the software transfers the digital data from memory to disk), again updates the .wav file header, and extends the length of the .wav file to include the data from the buffer (step 84). In addition, if a local database is utilized, the database record associated with the log file is updated with the call duration or other information related to the call such as a time stamp, a serial number associated with the telephone utilized for the telephone call, the telephone line utilized, unique call nomenclature, etc. (step 86). Whereas updating the database record may be done each time the length of the .wav file is increased (step 82), this is not preferred because it would result in numerous, unnecessary database connections. According to the preferred embodiment of the present invention, each recording creates a new .wav file and database record. However, .wav files occupy about 22,050 bytes per second of recording or about 1.3 Megabytes per minute of recording, and thus can occupy a very large amount of space. Those skilled in the art would recognize that this is about one-quarter the size of a compact disc (CD) quality music .wav file, as only one channel is needed. Also, the restricted frequency range of voice (as opposed to music) means that a sampling rate of one-quarter that required by music may be used. Therefore, the recording is made utilizing 16-bit (2 bytes) sampling, which provides sufficient data to allow the compression algorithm to create a quality recording. Nevertheless, a telephone call saved as a .wav file will still be quite large. Accordingly, the .wav file is preferably converted into a .wma file (i.e., a file that is compatible with Microsoft® Windows® Media Player) (step 88). However, any compressed audio format (.mp3, .mp4, .ogg, etc.) may also be utilized with the present invention. As will be understood by those skilled in the art, the conversion from a .wav format to a .wma format may be accomplished by either a custom conversion program or a utility program such as the Microsoft® Windows® Media 8 Encoding Utility, “wm8eutil.exe,” which is a Microsoft® command-line tool for converting uncompressed audio and video files to a Microsoft® Windows® Media format. This utility is generally available from Microsoft®'s web site. After converting the .wav file to a .wma file (step 88), the file size will be reduced by a factor of about 16.9:1. Once this is accomplished, the .wav file is no longer needed and is deleted (step 90). The .wma file is then transferred to server 42 for storage on storage medium 44 and added to the central database of server 42.

After a recording has ended, the information and the reference to the location of the .wma file are saved in the database (step 92). Whereas the actual call log file may be retained on the hard drive of the users' computers irrespective of the number of users, an important feature of the present invention is that multiple users utilizing different computers may use a single database to store information about their logged calls. In a multiple user system, the database will preferably be on the server's storage medium 44 (See FIG. 6). Thus, when the system in accordance with the present invention is used with multiple users, even if each user retains his respective logged call files, the single, centralized database created by the system allows any user to access any call in which that user, or any other user, participated, because the single, centralized database retains information about all calls, including the location (e.g., machine, drive, path, filename) of each log file.

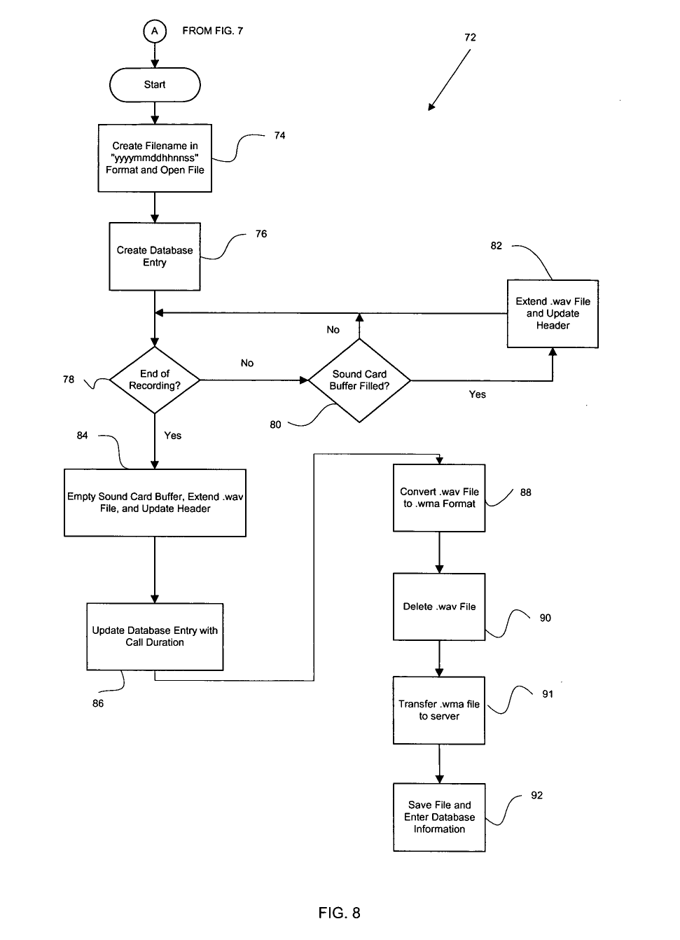

With reference now to FIG. 9, a circuit diagram of the telephone base-to-handset hardware interface 20 of FIG. 4 is shown. The telephone base-to-handset hardware interface includes a pair of isolation transformers 92 and 94, a resistor 96, and a capacitor 98. The first isolation transformer 92 transfers the audio frequency signals from the sound card speaker port 108 (See FIG. 2) to the telephone base 34 and telephone handset 18 (See FIG. 1) and the second isolation transformer 94 transfers the audio frequency signals from the telephone base 34 or telephone handset 18 (See FIG. 1) to the sound card microphone port 110 or the sound card line-in port 112 (See FIG. 2). The first isolation transformer 92 comprises a first winding 140 with two ends 148 and 150 and a second winding 142 with two ends 152 and 154. Both ends 148 and 150 of the first winding 140 are coupled to a connector 100 which interfaces the telephone base-to-handset hardware interface 20 to the telephone base 34 (See FIG. 1). Both ends 152 and 154 of the second winding 142 are coupled to a connector 104, which interfaces the telephone base-to-handset hardware interface 20 to the sound card speaker port 108 (See FIG. 2). The second isolation transformer 94 comprises a first winding 144 with two ends 156 and 158 and a second winding 146 with two ends 160 and 162. One end 156 of the first winding 144 of the second isolation transformer 94 is coupled via the resistor 96 (which preferably has a value of 5.6 Kohms) to the connector 102, which interfaces the telephone base-to-handset hardware interface 20 to the handset 18 (See FIG. 1) and the telephone base 34 (See FIG. 1). The other end 158 of the first winding 144 of the second isolation transformer 94 is also coupled to connector 102 via the capacitor 98 (which preferably has a value of about 10 microfarads). Both ends 160 and 162 of the second winding 146 are coupled to a connector 106, which interfaces the telephone base-to-handset hardware interface 20 to the sound card microphone port 110 or the sound card line-in port 112 (See FIG. 2).

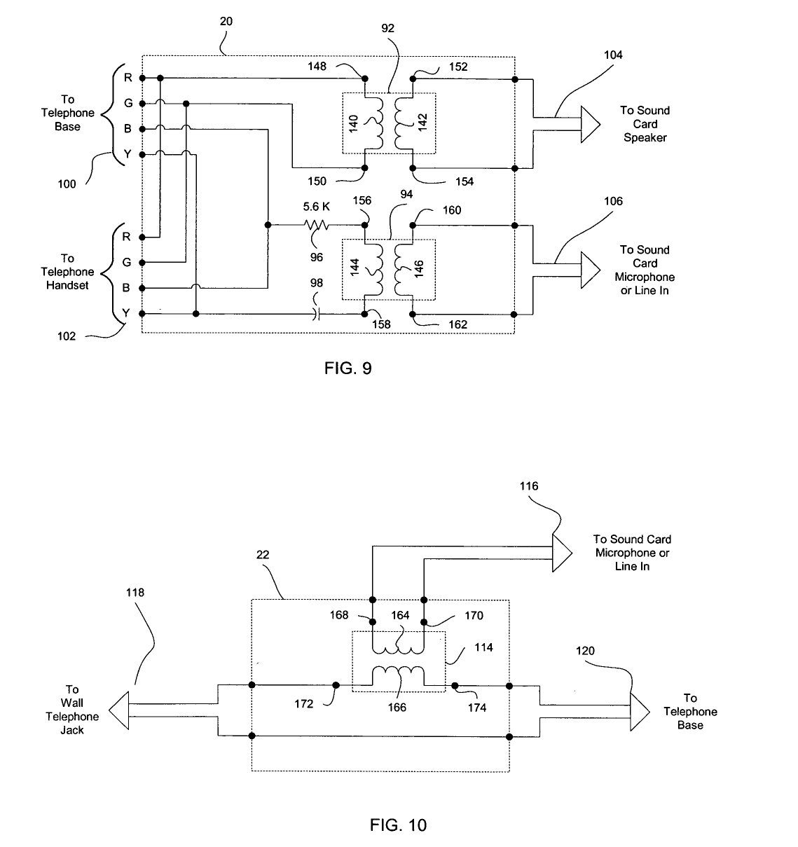

Referring next to FIG. 10, shown is a circuit diagram of an alternative embodiment of the telephone line-to-telephone base hardware interface 22 of FIG. 5. The telephone line-to-telephone base hardware interface 22 is preferably comprised of an isolation transformer 114, which transfers audio frequency signals from the wall telephone jack connector 118 to the sound card microphone port 110 or sound card line-in port 112 (See FIG. 2). The isolation transformer 114 comprises a first winding 164 with two ends 168 and 170 and a second winding 166 with two ends 172 and 174. Both ends 168 and 170 of the first winding 164 are coupled to the connector 116, which interfaces the telephone line-to-telephone base hardware interface 22 to the sound card microphone port 110 or the sound card line-in port 112 connector (See FIG. 2). One end 172 of the second winding 166 is coupled to a wall telephone jack connector (RJ-11) 118, which interfaces the telephone line-to-telephone base hardware interface 22 to a wall telephone jack. The other end 174 of the second winding 166 of the isolation transformer 114 is coupled to a connector (RJ-11) 120, which interfaces the telephone line-to-telephone base hardware interface 22 to the telephone base 34 (See FIG. 1). When the telephone line-to-telephone base 22 is configured as illustrated in FIG. 10, the telephone handset 18 may not be used to listen to recordings, as there is no electrical path from the computer 12 back to the telephone handset 18 (See FIG. 1).

Next, shown in FIG. 11 is a circuit diagram of the telephone base-to-handset hardware interface 130 that may be used as an alternative to the telephone base-to-handset hardware interface 20 illustrated in FIG. 9. As depicted in FIG. 11, the telephone base-to-handset hardware interface 130 includes an isolation transformer 132, such as a 600-ohm to 600-ohm audio frequency transformer, which transfers the audio frequency signals from the telephone base 34 (See FIG. 1) to the connector 138, which may connect the telephone base-to-handset hardware interface 130 to a sound card. The isolation transformer 132 comprises a first winding 176 with two ends 180 and 182 and a second winding 178 with two ends 184 and 186. Both ends 180 and 182 of the first winding 176 are coupled to a first connector 134, such as a male RJ9 connector, which interfaces the telephone base-to-handset hardware interface 130 to the telephone base 34 (See FIG. 1), and are also coupled to a second connector 136, such as a female RJ9 connector, which interfaces the telephone base-to-handset hardware interface 130 to the handset 18 of the telephone (See FIG. 1). Both ends 184 and 186 of the second winding 178 are coupled to a connector 138, such as a male 3.5 mm stereo microphone connector, which interfaces the telephone base-to-handset hardware interface 130 to the sound card microphone port 110 or the sound card line-in port 112 (See FIG. 2). When the telephone base-to-handset hardware interface 130 is configured as illustrated in FIG. 10, the telephone handset 18 may not be used to listen to recordings, as there is no electrical path from the computer 12 back to the telephone handset 18 (See FIG. 1). Designs using other means of isolation may also be used such as replacing the audio isolation transformer with a circuit using a photo coupler or similar device.

If a voice modem or other telephony device 16 (See FIG. 3) is used instead of a telephone base-to-handset hardware interface 20 or telephone line-to-telephone base hardware interface 22, then the voice modem or other telephony device 16 will have a first jack 122 to connect an RJ-11 plug from the wall, and a second jack 124 to connect an RJ-11 plug from the telephone base 34. Use of a voice capable modem allows the present invention to use caller identification information and to automatically include a caller's telephone number in the database. Whereas a voice modem will not allow the present invention to be utilized with a digital telephone line, the voice modem does allow the present invention to be used with speakerphones and cordless telephones. Alternatively, telephony cards may also be utilized. As is known in the art, the operation of telephony cards is similar to the operation of a voice modem. In yet another alternative, analogue data sampling cards or a USB sound device can be used to record the conversation. A USB device is simply plugged into an available USB port on the computer to work.

All hardware embodiments of the present invention are also compatible with hardware that provides, what is commonly known in the art as, a “beep tone.” A beep tone is an indication to a caller that the telephone conversation is being recorded and is required by law in certain states.

With reference now back to FIG. 2, there may be times when it is useful to utilize a computer as a sound recording device to record local voice messages or conversations, rather than to log telephone messages. At such times, a microphone 111 may be connected to the sound card microphone port 110, such that the system of the present invention may be used to accomplish the recording.

In accordance with the preferred embodiment of the system of the present invention, a user is allowed to log telephone calls, and the single, centralized database provides a means whereby the logged telephone calls may be readily retrieved for review by any user.

Another function of the system allows a user to send a copy of the .wma call log file to others via e-mail by using the Internet 48 (See FIG. 6). This allows logged calls to be, for example, collected by a customer service operation in one location and then passed on to management operations in a second location, or service personnel in yet another location. By way of example, a customer service function of a computer company could receive calls from customers who need service. The customer service personnel may log the calls while directing the customer to ship a defective unit in for repair. The database may be notated to include the return merchandise authorization “RMA” number that is assigned to the defective unit. Later, when the merchandise is returned, a technician will be able to match the RMA number to the customer's call and listen to the call to confirm that all complained of problems have been resolved.

Finally, another feature for use in the present invention is a method in which a user may flag a recording for another user's or group's attention.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

What is claimed is:

1. A system for recording, uploading, and securely downloading a telephone conversation comprising:
a call logging device for logging and uploading audio signals to a user including
a telephone,
a computer,
a circuit to interface said telephone to said computer such that said computer receives audio signals from said telephone, and
prompt means to provide information to users of said call logging device;
a central server comprising a storage medium for storing said audio signals and a database for storing an identification tag identifying said audio signal wherein said storage medium and said database are remotely accessible;
a communications means to enable said call logging device and said central server to communicate; and
a means for restricting access to said storage medium and said database.

2. A system according to claim 1, wherein said identification tag comprises at least one searchable criteria.

3. A system according to claim 2, wherein said searchable criteria includes a user name.

4. A system according to claim 1, wherein the system allows an administrator full access to the system to search for audio signals based on at least one criteria related to said identification tag of the audio signals.

5. A system according to claim 1, wherein said searchable criteria includes a time stamp.

7. A system according to claim 1, wherein said searchable criteria includes a date stamp.

8. A system according to claim 2, wherein said searchable criteria includes a caller's name.

9. A system according to claim 2, wherein said searchable criteria includes a caller number automatically received from a telephone network.

10. A system according to claim 1, wherein said prompt means instructs users of said call logging device to enter identification data relating to said audio recording.

11. A system according to claim 2, wherein said searchable criteria includes user responses to said prompting.

12. A system for securely logging and retrieving telephone audio recordings wherein said system comprises:
at least one call logging device comprising a telephone, a computer, and a circuit to interface said telephone to said computer such that said computer receives audio signals from said telephone;
at least one server comprising a storage medium and a database for storing an identification tag identifying said audio signal;
a communications means to enable said call logging device and said central server to communicate wherein said call logging device sends data representative of said audio signals from said telephone via said communications means to said central server; and
an interface means provided by said server to enable users to remotely access information stored in said central server.

13. A system according to claim 12, wherein said communications means comprises a local area network (LAN).

14. A system according to claim 12, wherein said communications means comprises a wide area network (WAN).

15. A system according to claim 12, wherein said communications means comprises the Internet.

16. A system according to claim 12, wherein said communications means comprises a secure interface.

17. A system according to claim 12, wherein said call logging device further comprises a prompting means for prompting a user to enter data relating to said audio recording.

18. A system according to claim 17, wherein user responses to said prompting is stored in said database.

19. A system according to claim 12, wherein said storage medium and said database are accessible to authorized remote users through said interface means.

20. A system according to claim 12, wherein said interface means is accessible by remote users through a web-browser.

21. A method for logging audio recordings, such as telephone conversations, comprising the steps of:
creating a central digital file on a central server;
naming said central digital file;
creating an entry in a database on a central server for storing information about said central digital file;
receiving an audio signal via an audio device;
converting said audio signal to a temporary digital file;
uploading said temporary digital file to said central server;
storing said temporary digital file in said central digital file;
saving information about said central digital file in said database; and
assigning access rights to said central digital file and said entry in said database.

22. A method according to claim 21, said method further comprising the step of:
automatically generating an electronic mail message containing said central digital file.
